(19) United States
(12) Patent Application Publication
(10) Pub. No.: US 2009/0302732 A1
(43) Pub. Date: Dec. 10, 2009

(54) ALLOYS FOR SPARK IGNITION DEVICE ELECTRODE SPARK SURFACES

(76) Inventor: James D. Lykowski, Temperance, MI (US)

Correspondence Address: ROBERT L. STEARNS;Dickinson Wright PLLC, Ste. 2000, 38525 Woodward Avenue, Bloomfield Hills, MI, 48304-2970, US

(21) Appl. No.: 12/398,417

(22) Filed: Mar. 5, 2009

Related U.S. Application Data
(60) Provisional application No. 61/034,630, filed on Mar. 7, 2008.

(51) Int. Cl. H01T 13/20

(52) U.S. Cl. 313/141

(57) ABSTRACT

An electrode for a spark ignition device, including a spark plug, which includes an alloy consisting essentially of, in weight percent, at least 15% Ni and the balance substantially Pt, and more particularly 15-45% Ni and the balance substantially Pt; 5-35% W, and the balance substantially Pd; and 5-15% Ni, 5-15% Pt, less than 10% Ir, and the balance substantially Pd.

This application claims priority to U.S. Application Ser. No. 61/034,630, filed Mar. 7, 2008, and is incorporated herein by reference.

### BACKGROUND OF THE INVENTION

1. Technical Field

This invention relates generally to materials for spark plug electrodes and, more particularly, to materials for use on the sparking surfaces of spark plug electrodes.

2. Related Art

Nickel and nickel-base alloys, including nickel-iron-chromium alloys like those specified under UNS N06600 and sold under the trade names Inconel 600®, Nicrofer 7615®, and Ferrochronin 600®, are in wide use as spark plug electrode materials. These materials are susceptible to high temperature oxidation and other degradation phenomena which result in erosion and corrosion, particularly of the sparking surfaces.

Various noble metal alloys have been suggested to improve the high temperature performance of spark plug electrodes, particularly in the form of all manner of sparking tips or pads applied to them to from their sparking surface. Current materials for spark plug electrode precious metal enhanced spark surfaces are primarily high platinum or high iridium alloys (generally greater than 90% by weight). Examples include pure iridium and pure platinum, as well as a number of platinum and iridium alloys, including those having the compositions, in weight percent, Pt with up to 10% Ni, Pt with up to 4% W, Pt with up to 20% Ir and Ir with up to 10% Rh which may also include one or both of W or Zr as an alloying constituent. These materials generally have high material cost or high material processing costs or both. In addition, the costs of these materials continually fluctuate making it difficult to design and specify them without making allowances for fluctuating cost, which itself involves additional cost.

Therefore, it is desirable to identify additional alloy materials that may be used as the sparking surfaces for spark plug electrodes.

### SUMMARY OF THE INVENTION

In general terms, this invention provides alternative center and ground electrode sparking tip materials to provide similar or enhanced performance at substantially reduced material and processing cost over current materials. The materials of this invention may be substituted for current materials when the market price for their constituents, taking into consideration the relative amounts of each constituent, is lower than the market price of the constituents of current materials, taking into consideration the relative amounts of each of their constituents. The primary performance criteria are electrical erosion resistance; resistance to high temperature corrosion from oxidation, sulfidation and other combustion constituents or reaction products; formability to wire, pads, balls, rivets and other shapes used for electrodes or sparking tips; and weldability to base electrode materials, including Ni-base and Fe-base alloys.

In one aspect, the electrode of a spark ignition device may include an alloy composition consisting essentially of, in weight percent, 15-45% Ni and the balance substantially Pt, and more particularly may comprise an alloy composition consisting essentially of, in weight percent, 30% Ni and the balance substantially Pt.

In another aspect, the electrode of a spark ignition device may include an alloy composition consisting essentially of, in weight percent, 5-35% W, and the balance substantially Pd, and more particularly may comprise an alloy composition consisting essentially of, in weight percent, 20% W, and the balance substantially Pd.

In another aspect, the electrode of a spark ignition device having the compositions described herein may also include at least one reactive element selected from the group consisting of: yttrium, hafnium, lanthanum, cerium, zirconium, tantalum and neodymium, and more particularly may comprise an alloy composition which includes, in weight percent, about 0.01-0.2% of the reactive element, and even more particularly about 0.1-0.2% of the reactive element. The reactive element may also include a plurality of the reactive elements in any combination.

In another aspect, the invention includes a spark plug having an electrode of the alloy compositions described having a generally annular ceramic insulator; a conductive shell surrounding at least a portion of the ceramic insulator; a center electrode disposed in the ceramic insulator having a terminal end and a sparking end with a center electrode sparking surface; and a ground electrode operatively attached to the shell having a ground electrode sparking surface located proximate the center electrode sparking surface, the center electrode sparking surface and said ground electrode sparking surface defining a spark gap therebetween; wherein at least one of the center electrode sparking surface or the ground electrode sparking surface comprises an alloy of the invention.

These and other features and advantages of this invention will become more apparent to those skilled in the art from the detailed description of a preferred embodiment. The drawings that accompany the detailed description are described below.

### BRIEF DESCRIPTION OF THE DRAWINGS

These and other features and advantages of the present invention will become more readily appreciated when considered in connection with the following detailed description and appended drawings, wherein like numbers are used to identify like elements in the several views:

FIG. 1 is a partial cross-sectional view of an exemplary spark plug including ground and center electrodes having a high temperature sparking tip which includes an alloy according to the invention;

FIG. 2 is a cross-sectional view of region 2 of FIG. 1;

FIG. 3 is a cross-sectional view of region 3 of FIG. 1 illustrating alternate ground and center electrode configurations to those shown in FIG. 1 having thermally conductive cores;

FIG. 4 is a plot of the gap growth rate following accelerated life testing for the alloys of the invention and several comparative examples;

FIG. 5 is an enlarged plot of the gap growth rate following accelerated life testing for the alloys of the invention and several comparative examples;

FIG. 6 is a reproduction of the Pt—Ni binary phase diagram and a plot of certain representative phases existing therein;

FIG. 7A is a photographs of a rivet of a Pt-30Ni alloy of the invention in the as-manufactured condition;

FIG. 7B is a photographs of a rivet of a Pt-30Ni alloy of the invention after 300 hours of accelerated life testing;

FIG. 7C is a photographs of a rivet of a Pt-10Ni alloy of the invention in the as-manufactured condition;

FIG. 7D is a photographs of a rivet of a Pt-10Ni alloy of the invention after 300 hours of accelerated life testing;

FIG. 8 is a graph of the spark gap growth as a function of test cycles/hours for Pt-10Ni;

FIG. 9 is a graph of the cost of several prior art alloys and pure noble metals normalized to the cost of Pt-10Ni.

FIG. 10 is a graph of cost of the alloys of the invention as well as several comparative example alloys normalized to the cost of Pt-10Ni.

### DETAILED DESCRIPTION OF PREFERRED EMBODIMENTS

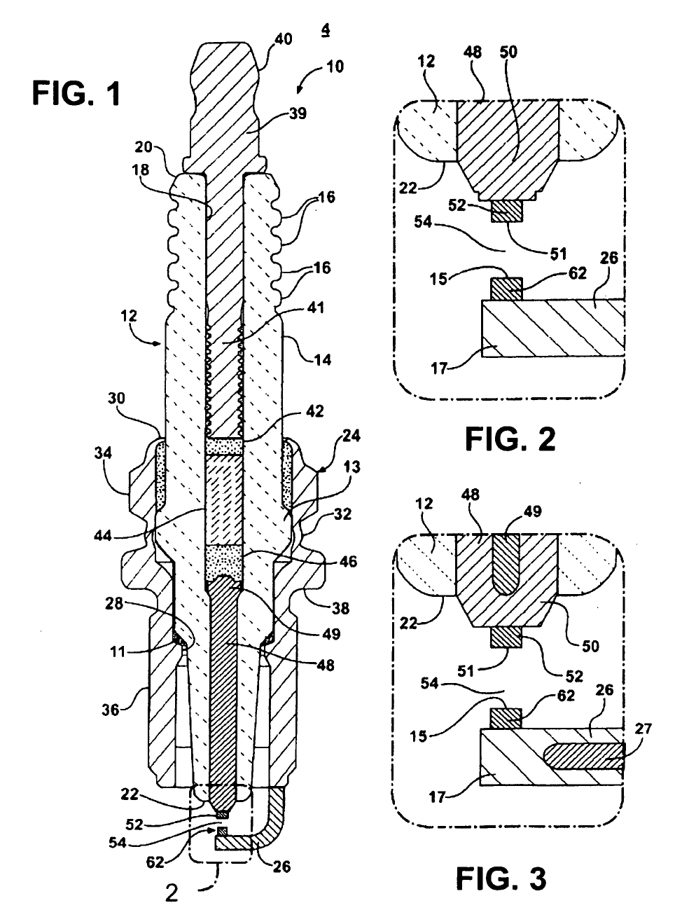

Referring to FIGS. 1-3, a representative spark ignition device used for igniting a fuel/air mixture is shown. Spark ignition devices contemplated by the invention include, without limitation, various configurations of spark plugs, glow plugs, spark igniters and the like, but is particularly adapted for use in various spark plug electrode configurations. The electrodes of an ignition device such as a spark plug are essential to the function of the device. In spark ignition devices, such as spark plugs, the alloys used for the electrodes are exposed to the most extreme temperature, pressure, chemical corrosion and physical erosion conditions experienced by the device. These include exposure of the electrode alloys to numerous high temperature chemical reactant species associated with the combustion process which promote oxidation, sulfidation and other corrosion processes, as well as reaction of the plasma associated with the spark kernel and flame front which promote erosion of the sparking surface of the electrode. The electrodes are also subject to thermo-mechanical stresses associated with the cyclic exposure to extreme temperatures, particularly to the extent corrosion processes form corrosion products on the electrode surfaces having different physical and mechanical properties, such as coefficients of thermal expansion, than the electrode alloy. Also, where noble metal spark tips are mechanically deformed, welded or otherwise attached to the electrode ends as sparking surfaces, there are additional cyclic thermo-mechanical stresses associated with the mismatch in the thermal expansion coefficients of the noble metal tip and the electrode materials which can result in various high temperature creep deformation, cracking and fracture phenomena, resulting in failure of the noble metal tips and electrodes. All of these represent processes by which the properties of the electrodes may be degraded, particularly they can result in changes in the spark gap and thus changes in the formation, location, shape, duration and other characteristics of the spark, which in turn affects the combustion characteristics of the fuel/air mixture and performance characteristics of the engine.

Ignition devices contemplated by the invention include electrodes having sparking surfaces, or tips fabricated of alloys which have comparable, and in some cases improved, resistance to the degradation problems described above in connection with prior know sparking tip materials, such as pure iridium and pure platinum, as well as a number of platinum and iridium alloys, including those having the compositions, in weight percent, Pt with up to 10% Ni, Pt with up to 4% W, Pt with up to 20% Ir, and Ir with up to 10% Rh and which may also include one or both of W or Zr as an alloying constituent.

Referring still to FIGS. 1-3, a representative spark plug device 10 includes an annular ceramic insulator, generally indicated at 12, which may be fabricated of aluminum oxide or other electrically insulating material suitable for use as a spark plug insulator with an appropriate dielectric strength, high mechanical strength, high thermal conductivity, and excellent resistance to thermal shock as well know to those of ordinary skill in the field of manufacturing spark plugs.

The insulator 12 may be press molded from a ceramic powder in a green state and then sintered at a high temperature sufficient to densify and vitrify the ceramic powder. The insulator 12 has an outer surface which may include a partially exposed upper mast portion 14 to which a rubber or other insulating spark plug boot (not shown) surrounds and grips to electrically isolate an electrical connection of the terminal end 20 of the spark plug with an ignition wire and system (not shown). The exposed mast portion 14 may include a series of ribs 16 or other surface glazing or features to provide added protection against spark or secondary voltage flash-over and to improve the gripping action of the mast portion with the spark plug boot. The insulator 12 is of generally tubular or annular construction, including a central passage 18 extending longitudinally between an upper terminal end 20 and a lower core nose end 22. The central passage 18 generally has a varying cross-sectional area, generally greatest at or adjacent the terminal end 20 and smallest at or adjacent the core nose end 22.

An electrically conductive metal shell is generally indicated at 24. Metal shell 24 may be made from any suitable metal, including various coated and uncoated steel alloys, including those having Ni-base alloy coatings. The shell 24 has a generally annular interior surface which surrounds and is adapted for sealing engagement with the exterior surface of the mid and lower portions of the insulator 12 and includes at least one attached ground electrode 26 which is maintained at ground potential. While ground electrode 26 is depicted in a commonly used single L-shaped style, it will be appreciated that multiple ground electrodes of straight, bent, annular, trochoidal and other configurations can be substituted depending upon the intended application for the spark plug 10, including two, three and four electrode configurations, and those where the electrodes are joined together by annular rings and other structures used to achieve particular sparking surface configurations. The ground electrode 26 has one or more ground electrode sparking surfaces 15, on a sparking end 17 proximate to and partially bounding a spark gap 54 located between ground electrode 26 and a center electrode 48 which also has an associated center electrode sparking surface 51. The spark gap 54 may constitute an end gap, side gap or surface gap, or combinations thereof, depending on the relative orientation of the electrodes and their respective sparking ends and surfaces. Ground electrode sparking surface 15 and center electrode sparking surface 51 may each have any suitable cross-sectional shape, including round, rectangular, square and other shapes, and these shapes may be different for the respective sparking surfaces.

The shell 24 is generally tubular or annular in its body section and includes an internal lower compression flange 28 adapted to bear in pressing contact against a small mating lower shoulder 11 of the insulator 12. The shell 24 generally also includes an upper compression flange 30, which is crimped or formed over during the assembly operation to bear on a large upper shoulder 13 of the insulator 12. Shell may also include a deformable zone 32 which is designed and adapted to collapse axially and radially inwardly in response to heating of deformable zone 32 and associated application of an overwhelming axial compressive force during or subsequent to the deformation of upper compression flange 30 in order to hold shell 34 in a fixed axial position with respect to insulator 12 and form a gas tight radial seal between insulator 12 and shell 24. Gaskets, cement, or other sealing compounds can also be interposed between insulator 12 and shell 24 to perfect a gas-tight seal and to improve the structural integrity of assembled spark plug 10.

Shell 24 may be provided with a tool receiving hexagon 34 or other feature for removal and installation of the spark plug in a combustion chamber opening. The feature size will preferably conform with an industry standard tool size of this type for the related application. Of course, some applications may call for a tool receiving interface other than a hexagon, such as slots to receive a spanner wrench, or other features such as are known in racing spark plug and other applications. A threaded section 36 is formed on the lower portion of metal shell 24, immediately below a sealing seat 38. The sealing seat 38 may be paired with a gasket (not shown) to provide a suitable interface against which the spark plug 10 seats and provides a hot gas seal of the space between the outer surface of the shell 24 and the threaded bore in the combustion chamber opening. Alternately, the sealing seat 38 may be designed as a tapered seat (not shown) located along the lower portion of the shell 24 to provide a close tolerance and a self-sealing installation in a cylinder head which is also designed with a mating taper for this style of spark plug seat.

An electrically conductive terminal stud 40 is partially disposed in the central passage 18 of the insulator 12 and extends longitudinally from an exposed top post 39 to a bottom end 41 embedded partway down the central passage 18. Top post connects to an ignition wire (not shown) which is typically embedded in an electrically isolating boot as described herein and receives timed discharges of high voltage electricity required to fire the spark plug 10 by generating a spark in spark gap 54.

Bottom end 41 of the terminal stud 40 is embedded within a conductive glass seal 42, forming the top layer of a composite three-layer suppressor-seal pack 43. Conductive glass seal 42 functions to seal the bottom end of terminal stud 40 and electrically connect it to a resistor layer 44. This resistor layer 44, which comprises the center layer of the three-layer suppressor-seal pack, can be made from any suitable composition known to reduce electromagnetic interference (“EMI”). Depending upon the recommended installation and the type of ignition system used, such resistor layers 44 may be designed to function as a more traditional resistor-suppressor or, in the alternative, as an inductive-suppressor, or a combination thereof. Immediately below the resistor layer 44, another conductive glass seal 46 establishes the bottom or lower layer of the suppressor-seal pack 43 and electrically connects terminal stud 40 and suppressor-seal pack 43 to the center electrode 48. Top layer 42 and bottom layer 46 may be made from the same conductive material or different conductive materials. Many other configurations of glass and other seals and EMI suppressors are well-known and may also be used in accordance with the invention. Accordingly, electrical charge from the ignition system travels through the bottom end of the terminal stud 40 to the top layer conductive glass seal 42, through the resistor layer 44, and into the lower conductive glass seal layer 46.

Conductive center electrode 48 is partially disposed in the central passage 18 and extends longitudinally from its head 49 which is encased in the lower glass seal layer 46 to its sparking end 50 proximate ground electrode 26. Center electrode sparking surface 51 is located on sparking end 50 and is located opposite ground electrode sparking surface 15, thereby forming a spark gap 54 in the space between them. The suppressor-seal pack electrically interconnects terminal stud 40 and center electrode 48, while simultaneously sealing the central passage 18 from combustion gas leakage and also suppressing radio frequency noise emissions from the spark plug 10 during its operation. As shown, center electrode 48 is preferably a one-piece structure extending continuously and uninterrupted between its head and its sparking end 50. It will be readily understood and within the scope of this invention that the polarity of the center electrode 48 during operation of the spark plug 10 may be either positive or negative such that the center electrode 48 has a potential which is either higher or lower than ground potential.

This is a representative construction of spark plug 10, but it will be readily appreciated that other spark plug 10 or ignition device constructions using insulator 12, shell 24 and electrodes 26 and 48 are possible in accordance with the present invention.

In accordance with the invention, either or both of center 48 and ground 26 electrodes will incorporate on their respective sparking surfaces 51, 15 a high temperature noble metal alloy as described herein below. This may be accomplished by forming the entirety of either or both of center 48 and ground 26 electrodes from the noble metal alloy, or alternately, for example, by forming a portion of the electrodes from a suitable non-noble metal combined with use of a noble metal sparking tip on the sparking end as described above. Where one or both of the electrodes includes a non-noble portion, either or both of center 48 and ground 26 electrodes may be made from any suitable conductive, non-noble material, including many high melting point metals, such as various Ni-base and Fe-base alloys. Examples includes various dilute Ni alloys and Ni-base superalloys, such as solution-strengthened Ni-based superalloys that include chromium and iron comprehended by the Unified Numbering System for Metals and Alloys (UNS) specification N06600, which includes alloys sold under the trademarks Inconel 600®, Nicrofer 7615®, and Ferrochronin 600®. The electrode alloy material compositions described above may also include at least one reactive element as an alloying addition to improve the high temperature strength and oxidation resistance. More particularly, the reactive elements may include at least one element selected from the group consisting of yttrium, hafnium, lanthanum, cerium, zirconium, tantalum and neodymium. However, any combination of reactive element alloying additions is comprehended within the scope of this invention. The reactive element may also include a plurality of reactive elements in any combination. Also more specifically, the compositional range of all reactive element alloying additions is about 0.01-0.2% by weight of the alloy, and more particularly about 0.1-0.2% by weight of the alloy.

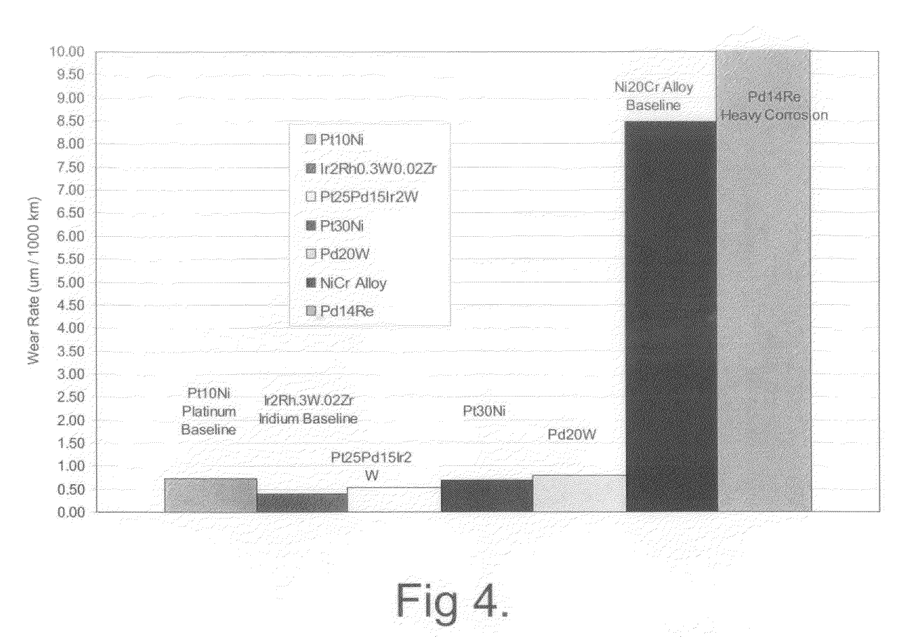

As shown in FIG. 3, in an alternate electrode configuration, either one or both of the ground electrode 26 and center electrode 48 can be provided with thermally conductive cores 27, 49, respectively, made from material of high thermal conductivity (e.g., ≧250 W/M*° K) such as copper or silver or various alloys of either of them. Highly thermally conductive cores serve as heat sinks and help to draw heat away from the spark gap 54 region, thereby lowering the operating temperature of the electrodes in this region and further improving their performance and resistance to the degradation processes described herein.

As shown in FIGS. 1-3, in accordance with the invention the spark plug 10 may also incorporate on the sparking ends of either or both of the ground electrode 26 or center electrode 48 a noble metal firing or sparking tip 62,52, respectively, of a high temperature noble metal alloy material that has either improved spark performance or resistance to the degradation processes described, or both of them. Center electrode 48 firing tip 52 is located on sparking end 50 of this electrode and has a sparking surface 51. Ground electrode 26 firing tip 62 is located on sparking end 17 of this electrode and has a sparking surface 15. Firing tips 52,62, include respective sparking surfaces 51, 15 for the emission of electrons across the spark gap 54. Firing tip 52 for the center electrode 48 and firing tip 62 for ground electrode 26 can each be made and joined according to any of a number of known techniques, including the formation and attachment, or the reverse, of various pad-like, wire-like or rivet-like firing tips by various combinations of resistance welding, laser welding, or combinations thereof. Firing tips 52, 62 may have any suitable size and cross-sectional shape or three dimensional form, including various cylinders, square or rectangular bars, partial spheres, hemispheres, cones, pyramids and other forms. Noble metal firing tips 52, 62 may also include composite or multi-layer structures which include a non-noble metal portion, such as may be attached to the center electrode 48 or ground electrode 26, respectively, and a noble metal portion which includes respective sparking surfaces 51, 15.

In accordance with the invention, either or both of center electrode 48 or ground electrode 26, or their respective firing tips 52, 62 may be made from various noble metal alloys in accordance with this invention. The noble metal alloys of the invention generally use higher concentrations of lower cost materials, including Ni and Pd, than currently used noble metal alloy without a loss of performance and in some cases with improvement in performance. This is an advantageous aspect of the alloys of the invention. Depending on market conditions, the materials of the invention may be available at lower total cost due to combinations of the amount of the constituent elements used, the constituent material cost, and lower material processing costs. Alloys of the invention have the further advantage that they may be qualified for use in production with regard to the performance criteria described and then substituted for current noble metal electrode materials when market conditions make it advantageous to do so. These alloys include several Pt-base and Pd-base alloys, where these elements are the primary constituent. It is particularly effective to use alloys of the invention that have already been commercialized for use in other industries and for other applications, such as for medical devices, interconnections and metallization layers of integrated circuits and jewelry, because these alloys are manufactured in sufficient volume so as to be readily available and subject to volume discounts and other commercial benefits, without the need for set-up and other charges associated with low volume or specialty applications.

One example of an alloy composition of the invention is a Pt-base alloy consisting essentially of, in weight percent, 15-45% Ni and the balance substantially Pt, and more particularly, an Pt-base alloy consisting essentially of 30% Ni and the balance substantially Pt. By substantially, it is meant that the balance is essentially Pt but may also include trace amounts of other elements. These trace elements may be incidental impurity elements. Typically incidental impurities are associated with the processes used to manufacture the noble metal alloy constituent materials or the processes used to form the noble metal alloy. However, if the purity of the other electrode constituents and the manufacturing process is controlled, these trace elements need not be incidental and their presence or absence and relative amounts may be controlled. The alloy is used for both sparking tips and is joined, such as by welding, to each of the respective electrodes without use of an intermediate, noble metal containing adhesion layer. In other words, the tips made of this alloy are joined directly to the base electrodes without need for any intervening layer of noble metal alloy material. The alloy is also essentially free of Iridium.

A second example of an alloy composition of the invention is a Pt-base alloy which includes, in weight percent, 20-45% Pd, 2-18% Ir, less than 5% W and the balance substantially Pt, wherein the amount of Pt is greater than 50%. More particularly, the invention includes a Pt-base alloy having, in weight percent, 25% Pd, 15% Ir, 2% W, and the balance substantially Pt.

A third example of an alloy composition of the invention is a Pd-base alloy consisting essentially of, in weight percent, 5-35% W, and the balance substantially Pd. More particularly, the invention includes a Pd-base alloy consisting essentially of, in weight percent, 20% W, and the balance substantially Pd.

A fourth example of an alloy composition of the invention is a Pd-base alloy consisting essentially of, in weight percent, 5-15% Ni, 5-15% Pt, less than 10% Ir, and the balance substantially Pd. More particularly, the invention includes a Pd-base alloy consisting essentially of, in weight percent, 10% Ni, 10% Pt, 5% Ir, and the balance substantially Pd.

Firing tips 52,62 may also be made from the alloys described in the examples above. Additional alloying elements for use in the alloys of the invention for firing tips 52,62 may include, reactive elements including yttrium, hafnium, lanthanum, cerium, zirconium, tantalum and neodymium. When used, the reactive element are generally added in an amount of about 0.01-0.2% by weight, and more particularly about 0.1-0.2% by weight.

Generally the use of higher concentrations of lower cost materials, including Ni and Pd, without the loss of performance and in some cases with improvement in performance is an advantageous aspect of the alloys of the invention. Depending on market conditions, the materials of the invention may be available at lower total cost due to combinations of the amount of the constituent elements used, the constituent material cost, and lower material processing costs. For example, processing costs may be lowered by the fact that the noble metal alloys of the invention may be used to form headed rivets or similar shapes by cold forming versus hot heading, grinding or electrode discharge machining (EDM) which is typically used to form other noble metal alloys, particularly many iridium alloys. In addition, alloys of the invention typically have lower melting temperatures than many iridium alloys, or higher platinum content alloys. Further, the alloys of the invention generally require fewer annealing cycles to be drawn into wire, rod, bar or other stock of a sufficient size for use as a center or ground electrode, or a firing tip for the same. Still further, alloys of the invention can generally be sheared due to their enhanced ductility as compared to many iridium alloys which require diamond cutting. Alloys of the invention have the further advantage that they may be qualified for use in production with regard to the performance criteria described and then substituted for current noble metal electrode materials when market conditions make it advantageous to do so.

### EXAMPLES

Several exemplary alloy materials of the invention were evaluated as sparking surfaces against several current sparking tip alloys and were found to have at least substantially similar, superior, and in several cases performance with regard to electrical erosion resistance; resistance to high temperature corrosion from oxidation, sulfidation and other combustion constituents or reaction products, as measured by the gap growth and gap growth rate of the spark gap as a function of time in accelerated life tests. They also exhibited substantially similar formability to wire, pads, balls, rivets and other shapes used for electrodes or sparking tips; weldability to base electrode materials, including Ni-base and Fe-base electrode alloys and other factors such that they may be readily manufactured and incorporated as sparking tips as a substitute for current precious metal sparking tip materials. The accelerated life tests performed and the results of the comparative examples are provided below.

Accelerated life tests were performed using spark plugs having identical configurations, including the sparking tips, using the different sparking alloy compositions of the invention described herein, as well as several current alloy compositions which were included as comparative examples.

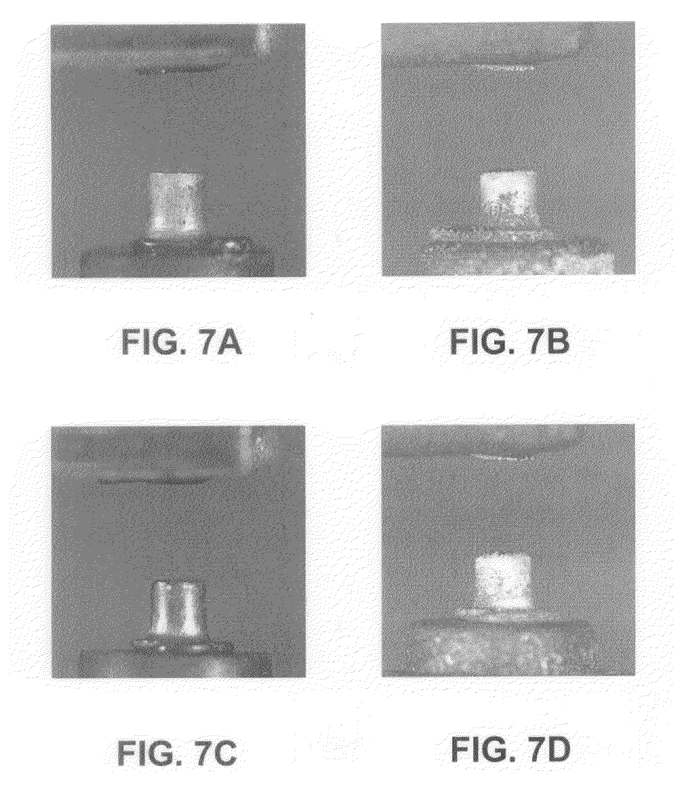

The spark plugs had the same overall configuration, including the shell, insulator, terminal stud, glass seal, center electrode and ground electrode. The center and ground electrodes included thermally conductive copper alloy cores, as shown in FIG. 3. The ground electrode in each case included a 1.2 mm diameter, 0.2 mm thick Pt-10Ni (in weight percent) pad attached by resistance welding. The center electrodes of the various sparking tip alloys tested incorporated sparking tips in the form of a 0.7 mm headed rivets as shown in FIGS. 7A-7D which were attached by resistance welding to achieve substantially similar weld joints for each of the alloy materials tested. The spark gap was 1.25 mm with the center electrode sparking tip being substantially axially centered over the center of the ground electrode pad. The sparking tip alloys of the invention were, in weight percent, Pt-30Ni and Pt-20W. In addition, several current sparking tip alloys were also tested for comparison, including, in weight percent, Pt-10Ni, Ir-2Rh-0.3W-0.02Zr and Ni-20Cr. The Ni-20Cr alloy is not a precious metal alloy, and was included as being representative of commonly used commercial spark plug electrode alloy compositions. The spark gap growth performance of the Ni-20Cr alloy is known to be very similar to a number of other commonly used electrode alloys, including various Ni—Cr—Fe alloys such as UNS N06600 (known under the trade name Inconel 600), pure Ni and many Ni-based alloys which do not include precious metal alloy constituents, such as a number of dilute Ni alloys, such as Ni—Cr—Mn and Ni—Al—Si—Y alloys. Dilute nickel alloys are high nickel alloys, having nickel contents that are generally greater than 90% by weight of the alloy, with small amounts of alloying elements, such as silicon, aluminum, yttrium, chromium, titanium, cobalt, tungsten, molybdenum, niobium, vanadium, copper, calcium, manganese and the like, to improve the high temperature properties over that of pure nickel, including enhanced resistance to high temperature oxidation, sulfidation and associated corrosive wear, as well as deformation, cracking and fracture associated with cyclic thermo-mechanical stresses resulting from operation of these devices.

A number of spark plugs incorporating sparking tips of each of the sparking tip alloys described above were subjected to accelerated wear tests in identical six cylinder 3.3 liter V-6 automotive engines. The engines were subjected to a one hour schedule where the engines were cycled repeatedly from idle to peak torque and peak power and back to idle. The one hour schedule was repeated for a total of 500 hours to achieve the accelerated life test. This 500 hour test has previously been correlated to about 100,000 miles of engine operation under typical driving/operating conditions. Generally, the size of the gap increases upon exposure to the operating environment. The rate of growth of the gap is of great commercial importance, since the gap growth rate of a particular sparking tip alloy relates indirectly to the serviceable life of the spark plug (i.e., those alloys having higher growth rates have shorter operating life times). If a particular operating lifetime must be achieved (e.g., 100,000 miles), this can be devolved to a maximum permissible gap growth rate. The gap growth rate for a particular alloy can be determine through the accelerated life testing described herein.

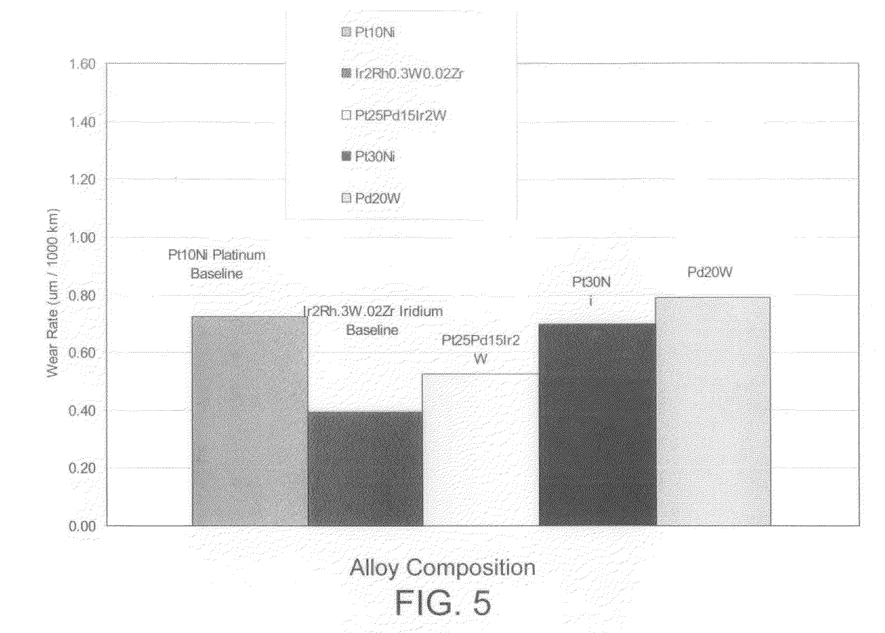

In these accelerated wear tests, test engines are cycled as described to achieve variability in engine/spark plug operating temperature of between about 400-800° C. This thermal cycling introduces cyclic thermal stresses in the spark plugs, particularly the sparking tips, due to the mismatch between the coefficients of thermal expansion of these alloys and the associated electrode materials. In addition, the dimensional variations due to variations in the operating temperature and coefficient of thermal expansion mismatches and speed variation of the engine and hence, voltage output of the ignition system, also act to introduce electrical stress variations due to changes which occur in the ignition system operating voltage and due to dimensional changes in the spark gap. Generally, the tests introduce variability into the electrical stress, particularly with respect to the sparking voltage, by varying the sparking voltage between about 5-30 kV. The variations in the spark gap were measured at 100 hour intervals. The gap information was converted to gap growth and a gap growth rate. The gap growth rate for the sparking tip alloys of the invention and the comparative alloys is shown in FIGS. 4 and 5. FIGS. 7A and 7B are photographs of a Pt-30Ni alloy of the invention in the as-manufactured condition (FIG. 7A) and after 300 hours of accelerated life testing (FIG. 7B). For comparison purposes, FIGS. 7C and 7D are photographs of a Pt-10Ni alloy in the as-manufactured condition (FIG. 7C) and after 300 hours of accelerated life testing (FIG. 7D).

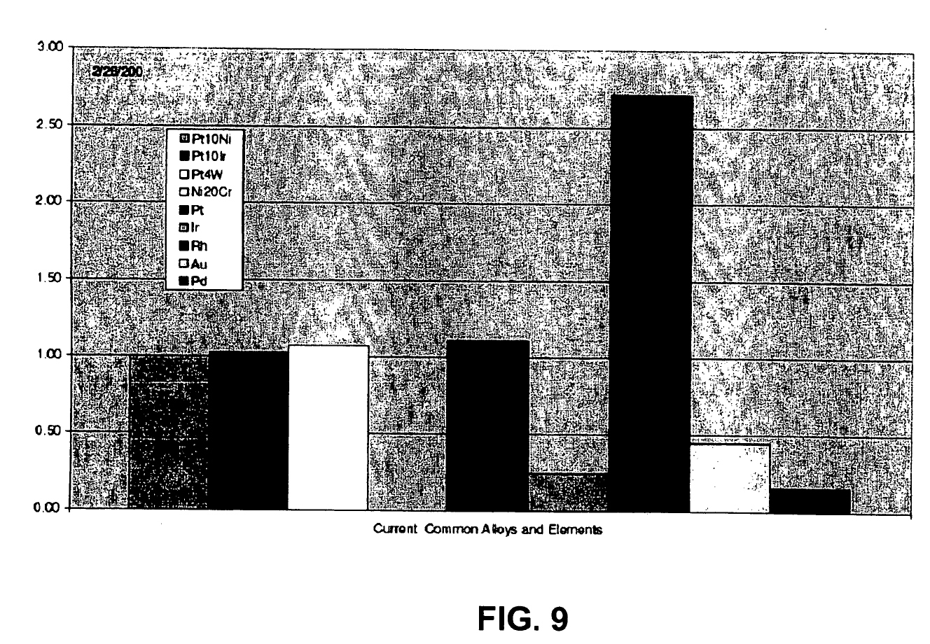

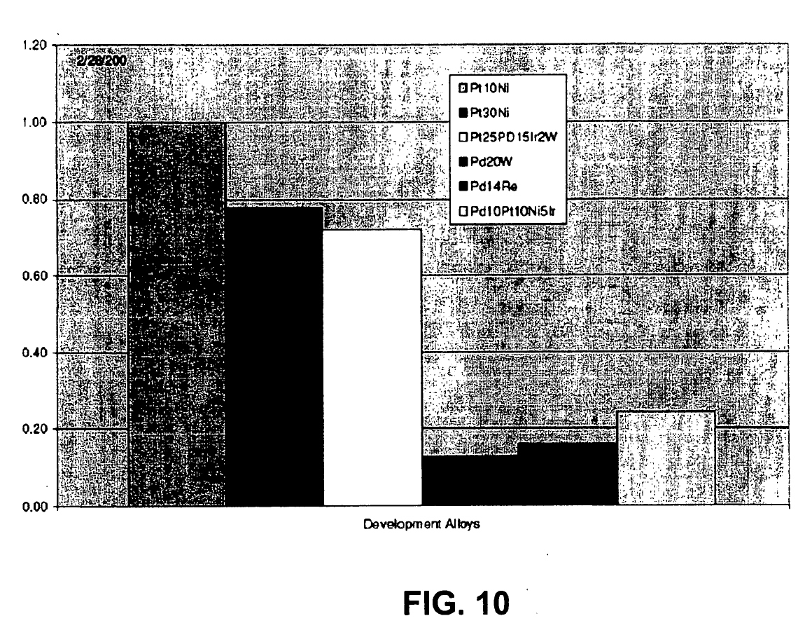

As shown in FIGS. 4 and 5, all of the alloys of the invention exhibited gap growth rates substantially similar to that of the precious metal comparative examples, namely Pt-10Ni, Ir-2Rh-0.3W-0.02Zr. By substantially similar, reference is made with regard to the non-precious metal comparative example, Ni-20Cr (FIG. 4). In other words, the largest differential between the precious metal alloys of the invention and the comparative example precious metal alloys was for Pd-20W which had a gap growth rate about 197% that of Ir-2Rh-0.3W-0.02Zr, and only 108% that of Pt-10Ni. Even the 197% larger growth rate is an improvement and substantially similar in the context of comparison between the growth rate performance of Ir-2Rh-0.3W-0.02Zr and Ni-20Cr, where the rate was about 2174% greater, and Pt-10Ni and Ni-20Cr where the rate was about 1178% larger. Further, all of the alloys except Pt-20W had better performance in comparison to the Pt-10Ni alloy, and the growth rate with Pt-20W was only about 110% that of the Pt-10Ni alloy. Thus, all of the alloys of the invention are believed to be commercially useful improvements over Pt-10Ni, Ir-2Rh-0.3W-0.02Zr and other known Pt and Ir alloys as they offer substantially similar gap growth rate performance at substantially less cost, as shown in FIGS. 9 and 10.

As also shown in FIGS. 4 and 5, a Pd—Re alloy, Pd-14Re, was also tested, but it did not exhibit acceptable performance as an alloy of the invention because it did not exhibit gap growth and gap growth rate performance that was substantially similar to that of Pt-10Ni.

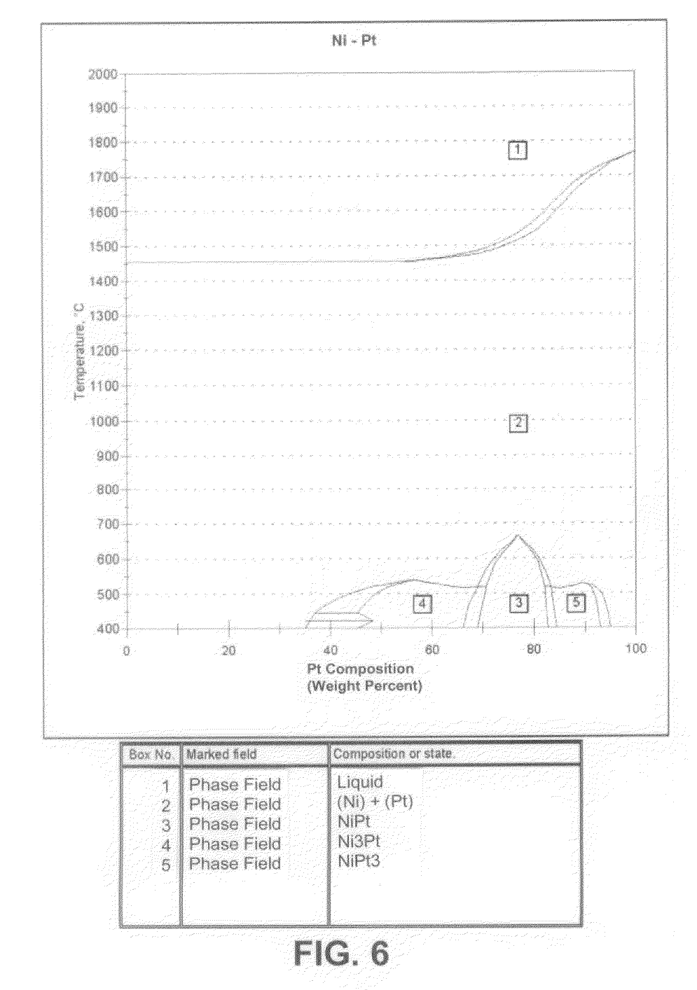

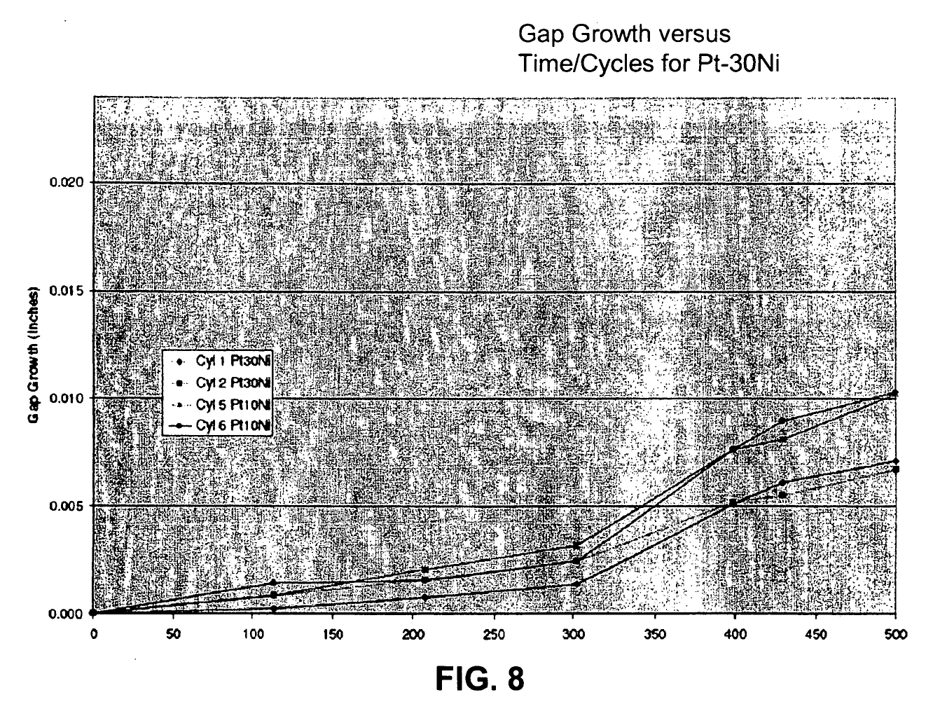

Of particular note was the performance of Pt-30Ni. The gap growth rate for this alloy was lower than that of the Pt-10Ni alloy. This was unexpected in view of the data obtained for the Ni-20Cr which, as noted above, is known to be similar to that of other non-noble spark plug electrode alloys, including Ni-base alloys such as those noted herein, as there does not appear to be a steadily increasing gap growth rate, linear or otherwise, with the progressive dilution of the platinum associated with an increasing amount of nickel, since the performance of Pt-30Ni which forms an equilibrium NiPt phase between about 400-500° C., a mixture of an equilibrium NiPt and Ni3Pt phases between about 500-600° C. and a solid solution of Ni and Pt above about 600° C. (see FIG. 6) was actually better than that of Pt-10Ni. The underlying gap and gap growth data for Pt-30Ni are shown in FIGS. 8 and 9. Referring to FIG. 6, the fact that the Ni—Pt phase diagram indicates that nickel and platinum of the Pt-30Ni alloy exist as solid solution at the upper end (i.e., between about 600-800° C.) of the operating temperature range of 400-800° C. suggests that similar gap growth rate performance may be achievable out to even higher concentrations of Ni, perhaps as much as 50% Ni or more, since Pt and Ni have complete solid solubility over the entire operating temperature range above about 65% Ni, and complete solid solubility between about 30-65% Ni over the portion of the operating range between about 525-800° C.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

I claim:

1. A spark ignition device having a center electrode and a ground electrode fabricated of non-noble metal based alloys and each including a noble metal-based firing tip joined to the respective electrodes to present respective sparking surfaces of said sparking tips defining a spark gap in a space therebetween, said sparking tips being fabricated of an alloy consisting essentially of, in weight percent, at least, 15% Ni and the balance substantially Pt and being joined directly to said center and ground electrodes without use of an intermediate noble metal containing adhesion material, and being essentially free of iridium.

2. The spark ignition device of claim 1, wherein said alloy consists essentially of, in weight percent, 15-45% Ni and the balance substantially Pt.

3. The spark ignition device of claim 1, wherein said alloy consists essentially of, in weight percent, 30% Ni and the balance substantially Pt.

4. The spark ignition device of claim 1, wherein said alloy further consists essentially of at least one reactive element selected from the group consisting of: yttrium, hafnium, lanthanum, cerium, zirconium, tantalum and neodymium.

5. The spark ignition device of claim 4, wherein said reactive element is present in an amount of 0.01-0.2% by weight.

6. A spark ignition device having a center electrode and a ground electrode and each including a noble metal-based firing tip joined to the respective electrodes to present respective sparking surfaces of said sparking tips defining a spark gap in a space therebetween, said sparking tips being fabricated of an alloy consisting essentially of, in weight percent, 20-45% Pd, 2-18% Ir, less than 5% W and the balance substantially Pt, wherein the amount of said Pt is greater than 50%.

7. The spark ignition device of claim 6, wherein said alloy comprises, in weight percent, 25% Pd, 15% Ir, 2% W, and the balance substantially Pt.

8. The spark ignition device of claim 6, wherein said alloy further comprises at least one reactive element selected from the group consisting of: yttrium, hafnium, lanthanum, cerium, zirconium, tantalum and neodymium.

9. The spark ignition device of claim 8, wherein said reactive element is present in an amount of 0.01-0.2% by weight.

10. A spark ignition device having a center electrode and a ground electrode and each including a noble metal-based firing tip joined to the respective electrodes to present respective sparking surfaces of said sparking tips defining a spark gap in a space therebetween, said sparking tips being fabricated of an alloy consisting essentially of, in weight percent, 5-35% W, and the balance substantially Pd and being substantially free of Ir.

11. The spark ignition device of claim 10, wherein said alloy consists essentially of, in weight percent, 20% W, and the balance substantially Pd.

12. The spark ignition device of claim 10, wherein said alloy further consists essentially of at least one reactive element selected from the group consisting of: yttrium, hafnium, lanthanum, cerium and neodymium.

13. The spark ignition device of claim 12, wherein said reactive element is present in an amount of 0.01-0.2% by weight.

14. A spark ignition device having a center electrode and a ground electrode and each including a noble metal-based firing tip joined to the respective electrodes to present respective sparking surfaces of said sparking tips defining a spark gap in a space therebetween, said sparking tips being fabricated of an alloy consisting essentially of, in weight percent, 5-15% Ni, 5-15% Pt, less than 10% Ir, and the balance substantially Pd.

15. The spark ignition device of claim 14, wherein said alloy consists essentially of, in weight percent, 10% Ni, 10% Pt, 5% Ir, and the balance substantially Pd.

16. The spark ignition device of claim 14, wherein said alloy further consists essentially of at least one reactive element selected from the group consisting of: yttrium, hafnium, lanthanum, cerium and neodymium.

17. The spark ignition device of claim 16, wherein said reactive element is present in an amount of 0.01-0.2% by weight.
